(19) United States
(12) Patent Application Publication
(10) Pub. No.: US 2004/0051808 A1
(43) Pub. Date: Mar. 18, 2004

(54) Compact optical imaging device

(76) Inventors: Hashem Akhavan-Tafti, Howell, MI (US); Jack Chambers, Webberville, MI (US); Richard Handley, Canton, MI (US); Barry Schoenfelner, Livonia, MI (US)

Correspondence Address: Gardere Wynne Sewell LLP, Tim Headley, 1000 Louisiana, Sutie 3400, Houston, TX, 77002-5007, US

(21) Appl. No.: 10/276,717

(22) PCT Filed: May 18, 2001
(86) PCT No.: PCT/US01/10823

(51) Int. Cl. H04N 5/225

(52) U.S. Cl. 348/373

(57) ABSTRACT

A compact apparatus for digital imaging of luminescent materials is provided. The apparatus can be readily transported by an individual and features a system of collapsible or foldable elements which allow it to be stored in a compact conliguration when not in use. The apparatus is contained within a case which when opened allows the apparatus to be placed into a use configuration by unfolding or otherwise extending the elements of the apparatus. The apparatus is useful for imaging a variety of materials and samples in life science applications.

This application claims priority from Provisional Application Ser. No. 60/205,069, filed May 18, 2000.

### FIELD OF THE INVENTION

The present invention relates to a compact apparatus for digital imaging of luminescent materials. More particularly, the invention relates to a portable imaging apparatus which can be readily transported by an individual. The apparatus features a system of collapsible or foldable elements which allow it to be stored in a compact configuration when not in use. The apparatus is contained within a case which when opened allows the apparatus to be placed into a use configuration by unfolding or otherwise extending the elements of the apparatus. The apparatus is useful for imaging a variety of materials and samples in life science applications.

### BACKGROUND OF THE INVENTION

Devices for recording images of objects which produce light or luminescence find application in the biomedical science for many uses. The form of the luminescence can be light produced by a chemical or biochemical reaction, i.e. chemiluminescence or bioluminescence. Another form is fluorescence or phosphorescence whereby a test sample or a substance is exposed to light of a first wavelength and light is emitted at a second wavelength. Optical filters which only transmit light of a certain wavelength range are used to discriminate emitted light. Several types of analyses make use of luminescent endpoints. Southern, northern and western blot assays can be performed by chemiluminescent visualization of bands on the blotting membrane. Microtiter plates, tubes and other types of samples having various shapes and dimensions are also imaged in different types of analyses.

Such devices typically use digital means for image capture so that image information can be readily stored, analyzed on computers and displayed on their associated output devices. Charge-coupled device (CCD) camera systems are specially common. Several dedicated, computer-controlled digital imaging systems are commercially available including the EAGLE EYE (Stratagene, La Jolla, Calif.), CHEMI IMAGER (Alpha Innotech, San Leandro, Calif.), BERTHOLD NIGHT OWL (Perkin-Elmer Life Sciences-Wallac, Turku, Finland), KODAK Image Station 440 CF (Eastman Kodak, Rochester, N.Y.), NUCLEOVISION 920 (Nucleotech Corp., San Mateo, Calif.), CHEMI, BIOCHEMI, OPTICHEMI SYSTEMS (UVP, Upland, Calif.), CCDBIO (Hitachi Genetic Systems, Alameda, Calif.), LAS-100PLUS (Fuji Film, Tokyo, Japan), and LUMI-IMAGER F1 (Roche Diagnostics Corp., Basel, Switzerland). These devices typically consist of a large cabinet containing the camera head at the top, a sample platform at the bottom with any necessary illumination devices and a large dark chamber defining the optical path interposed between the camera and sample platforms. Control functions for operating the camera are frequently built into the cabinet.

While these devices are capable of recording, analyzing, manipulating and storing digital image information from light-emitting samples, all are dedicated, free-standing and rather large instruments. All of these device ten to be large since they are designed to be more or less permanently installed at the research station. Moreover, the relative position of the components defining the optical path are essentially fixed within a rigid cabinet. No attempt appears to have been made to devise an easily portable imaging device which could perform imaging of a variety of types of biomedical samples. The present invention addresses this need by providing a compact device which fits inside of a carrying case and is expandable to a configuration for use.

### SUMMARY OF THE INVENTION

It is an object of the present invention to provide a portable apparatus for imaging luminescent materials and samples.

It is another object of the present invention to provide an apparatus for imaging luminescent materials wherein the apparatus is housed in a case.

It is a further object of the present invention to provide an apparatus for imaging luminescent materials constructed so as to be placed into a first storage configuration when the case is closed and then expanded into a use configuration when the case is opened by unfolding and otherwise expanding the elements of the apparatus.

It is another object of the present invention to provide an apparatus for imaging luminescent materials which is larger when in the use configuration than when in the closed configuration.

It is another object of the present invention to provide a portable apparatus for imaging luminescent materials sized to permit easy transportation by a person on a public conveyance.

### GENERAL DESCRIPTION

The present invention provides a compact, easily portable apparatus for imaging luminescent objects. The apparatus is contained within a carrying case which can be carried and transported by hand. The apparatus is constructed so as to be placed into a first storage configuration when the case is closed and then expanded into a use configuration when the case is opened by unfolding and otherwise expanding the elements of the apparatus.

The present invention provides an apparatus for imaging a luminescent object placed within the apparatus comprising a photon detection device, a dark chamber and a sample holder, wherein the apparatus is adapted for storage within a carrying case wherein the apparatus has a closed configuration for storage and an open configuration for use. The apparatus preferably has at least one dimension which is larger when in the open configuration than any dimension of the closed carrying case. In a preferred embodiment the apparatus has at least one dimension which is larger when in the open configuration than the corresponding dimension of the closed carrying case.

The apparatus further comprises an expandable enclosure element for providing a dark chamber and electronic means for producing electrical output signals coupled to the photon detection device.

In another embodiment the apparatus is attached to an inside surface of the carrying case.

In another embodiment the apparatus has length, width and depth outside linear dimensions whose sum does not exceed 45 inches when in a closed configuration.

An imaging apparatus in accordance with the present invention comprises:

an expandable enclosure element for providing a dark chamber;

a sample holding device;

a photon detection device mounted to a support element;

electronic means coupled to the photon detection device to produce electrical output signals, wherein the expandable enclosure element, sample holding device, photon detection device, support element and electronic means are contained within a carrying case.

In the apparatus the expandable enclosure element is attached to the support element and has a first retracted configuration for storage within the carrying case and a second expanded configuration for forming the dark chamber when the carrying case is in an opened configuration.

In preferred embodiments of the apparatus, the expandable enclosure element is selected from a photographic bellows device, a telescoping tube set and a flexible cloth or fabric. The dark chamber of the apparatus is formed by expanding the enclosure element to an expanded configuration and attaching it to the sample holding device.

The apparatus can further comprise at least one rigid support member positionable between the sample holding device and the support element to maintain a fixed separation between the photon detection device and the sample holding device.

In other embodiments of the apparatus, the photon detection device is selected from a CCD camera, a cooled CCD camera, an intensified CCD camera and a photomultiplier tube and can be connected by electronic means for supplying electrical output signals to a computer.

### BRIEF DESCRIPTION OF THE DRAWINGS

FIG. 1 is a side view of an apparatus in accordance with the present invention in the open configuration for use but with the flexible bellows not extended.

FIG. 2 is a side view of an apparatus in accordance with the present invention in the open configuration for use with the flexible bellows extended.

FIG. 3 depicts a top view of an apparatus in accordance with the present invention showing the CCD camera head mounted on the top of the top support plate.

FIG. 4A is a photograph of the apparatus in the open configuration for use but with the flexible bellows not extended.

FIG. 4B is a photograph of the apparatus in the open configuration for use with the flexible bellows extended.

FIG. 5 is a diagram of the underside of the top support plate showing the two L-brackets for engaging a bellows flange and a central hole for accommodating a camera lens.

FIG. 6 is a cross sectional diagram of the flexible bellows mounted to the underside of the top support plate by means of two L-brackets.

FIG. 7 is a diagram of the mating plate in bottom and cross sectional views.

FIG. 8 depicts a cross section and top views showing the assembly of the CCD camera head, mating plate, top support plate and camera lens.

FIG. 9 is a block diagram of the electronic signal system.

FIG. 10 is a digital image of a membrane from a dot blot experiment acquired using an apparatus of the present device.

FIG. 11 is a digital image of a membrane from a western blot experiment acquired using an apparatus of the present invention. The blot depicts the chemiluminescent detection of the protein β-galactosidase on nitrocellulose membrane with a horseradish peroxidase-labeled secondary antibody and Lumigen PS-3 chemiluminescent substrate.

FIG. 12 is a digital image of a membrane from a western blot experiment acquired using an apparatus of the present invention. The blot depicts the chemiluminescent detection of the protein β-galactosidase on PVDF membrane with a horseradish peroxidase-labeled secondary antibody and Lumigen PS-3 chemiluminescent substrate.

### DETAILED DESCRIPTION OF THE INVENTION

In a preferred embodiment the present invention provides a compact, easily portable apparatus for imaging luminescent objects. The apparatus is contained within a carrying case which can be carried and transported by hand. The apparatus is constructed so as to be placed into a first storage configuration when the case is closed and then expanded into a use configuration when the case is opened by unfolding and otherwise expanding the elements of the apparatus.

The carrying case will preferably have rigid sides and a handle and be of a style suitable for carrying by an individual. A metal case is preferred. Aluminum is preferred as a construction material because its light weight allows for easier transportability by a person. The case can optionally have wheels for easier transport. Suitable cases are manufactured by Zero Halliburton (North Lake, Utah). A suitable model is ZR107C which measures 13″×21″×7.5″ in its external dimensions. A case of these dimensions or smaller will meet the requirements for carry on baggage on commercial aircraft. A survey of the carry on luggage size restrictions of commercial domestic and foreign airlines shows that items having a maximum combined length, width and depth of 43″ to 50″ are permitted. The above specified case thus would meet these criteria. All of the art known devices described in the background section have dimensions exceeding these restrictions and could not be transported as carry on baggage.

Photon detection device is typically a camera and preferably a digital camera such as a CCD camera. Alternately a photomultiplier tube could be used for sensing and detecting photons of light. The CCD camera consists of a camera head, mating plate and camera lens. CCD camera heads of varying size, resolution (pixel size) number of pixels and A/D conversion bit depth and spectral sensitivity are available and can be used in the present invention. The wavelength sensitivity of the device chosen is governed by the color of light emitted by the luminescent sample. Camera systems employing CCD chip detection are preferable because of the availability of different chips exhibiting sensitivity to a wide range of wavelengths extending from ultraviolet to near infrared. Photomultiplier tubes frequently have a narrower wavelength sensitivity profile. Suitable CCD camera heads are available for example from astronomy equipment suppliers such as Santa Barbara Instrument Group (Santa Barbara, Calif.).

The expandable enclosure element provides a dark environment in which the object to be imaged is placed for imaging. The expandable enclosure element surrounds and encloses at one of its ends at least the outer portion, e.g. a lens, of the photon detection device and can surround the entire photon detection device. At the opposite end, the expandable enclosure element surrounds and encloses an area containing the sample by attaching to a surface of the sample holder. The seal is made by conventional means such as clamping or by means of fasteners but in a manner to seal against light leaks. Optional light baffling elements can be used, for example by attachment to or contact with the sample holder, to aid in rejecting stray light. The expandable element is of a design which allows it to be stored in a compact state by folding, pleating, retracting or the like and then expanded by the opposite process when the imaging apparatus is to be used. Preferred expandable elements are selected from a bellows device, a telescoping tube set, and a flexible cloth or fabric. The expandable element is made in a dark opaque color, preferably black in order to minimize stray light from reaching the photon detection device.

Suitable photographic bellows are manufactured by Toyo Photo Products and are available from photographic product suppliers. An 8×10 Standard Bellows TOYO model 180708 (11602) which extends to 27.5″, (700 mm) is an exemplary bellows useful in the present apparatus. Preferably the bellows has a wide internal frame to minimize internal vignetting when using extreme movements. Other size bellows can be used provided that it will fit within the carrying case and provide a dark chamber volume when expanded which is sufficiently long to accommodate the focal distance of the camera lens system used and has a sufficient cross sectional area to house the object to be imaged.

Suitable photographic lenses can be of any convenient focal length and aperture provided that they allow imaging of the necessary field of view predicated by the dimensions of the sample to be imaged. Variable focal length lenses are useful as well.

The photon detection device and expandable enclosure element are preferably attached and mounted onto a support plate. The plate is conveniently fabricated from metal for rigidity. The attachment of the photon detection device and expandable enclosure element to the support plate are by any conventional fastening means such as screws, bolts and the like. Additional mating plate members can be used to facilitate connection of the photon detection device or expandable enclosure element to the support plate. The attachment can be permanent or more preferably by means which allow removal and replacement for maximum design flexibility. The support plate can be designed to be held at a fixed distance from the sample holder when in the opened or use configuration. In another embodiment it can be positionable at a variable distance from the sample holder in a controlled manner. The support plate is preferably attached to the inside of the carrying case but can be unattached. When attached to the carrying case the support plate is preferably attached by a hinging mechanism which permits it to be folded into the case when the case is closed.

The sample holder in its simplest form is a rigid plate of any convenient size and shape which fits within the carrying case. The sample holder serves to support the sample being imaged and to maintain it at a specified distance from the camera when the apparatus is in the opened or use configuration. In one embodiment it can be held a fixed distance from the camera, in another embodiment it can be positionable at a variable distance from the camera in a controlled manner. The sample holder is preferably attached to the inside of the carrying case but can be unattached. When attached to the carrying case the sample holder is preferably attached by a hinging mechanism which permits it to be folded into the case when the case is closed. Other shape sample holders are also possible, for example, a tray which could be designed and fabricated to slide in and out of a small tray holder or cabinet. The plate or tray should have a surface area large enough to accommodate the types of samples which will typically be imaged. In life science applications this includes such objects as blotting membranes and microtiter plates.

Exemplary Apparatus

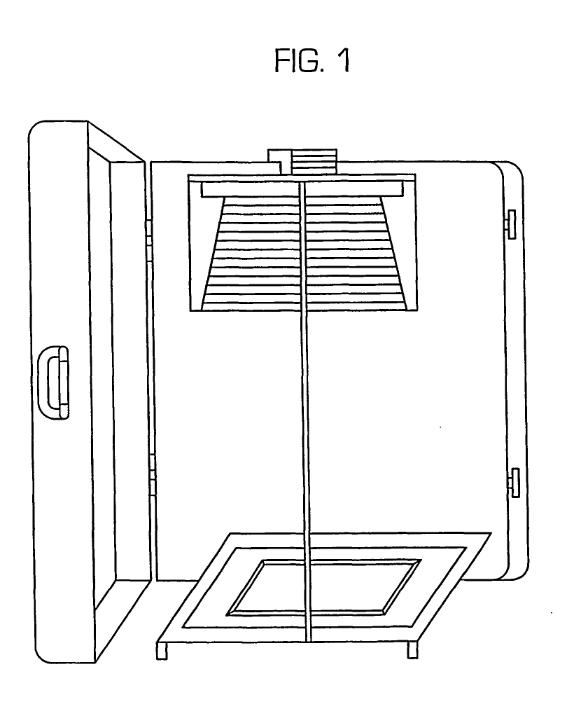

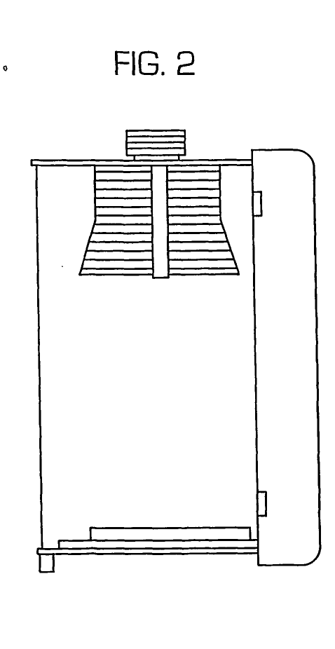

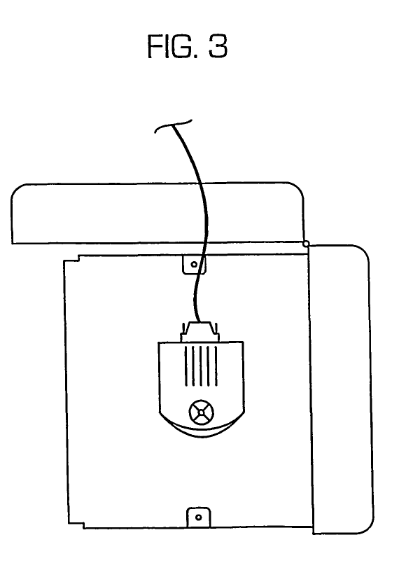

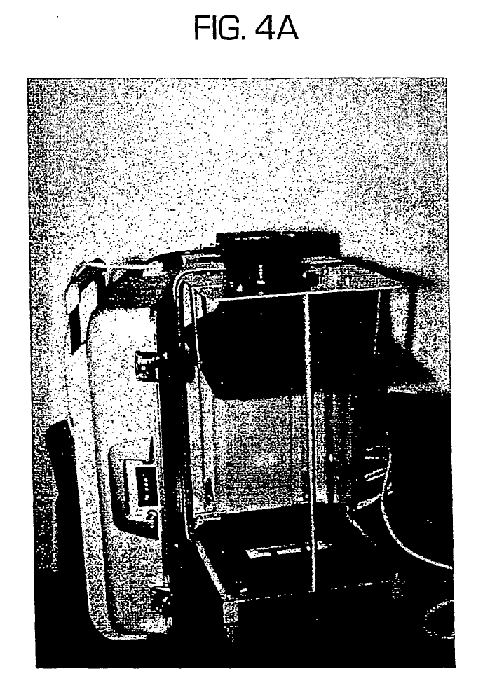

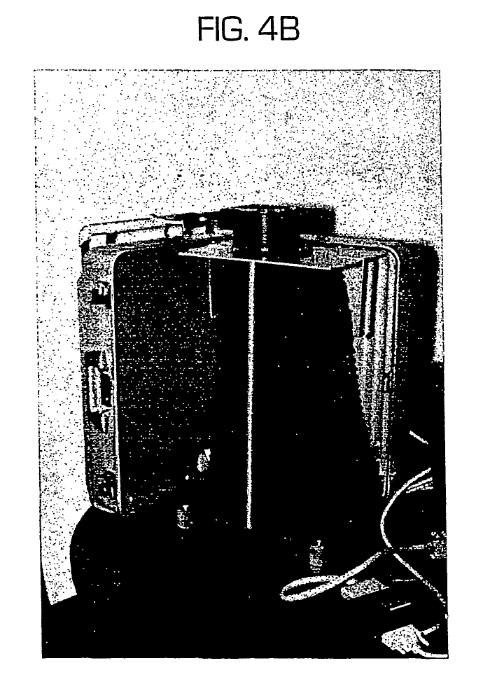

A preferred apparatus was constructed in accordance with the present invention and is depicted schematically in FIGS. 1-4. This apparatus having a total weight of 27-28 lbs. uses a Zero Halliburton model ZR107C case to contain all elements of the apparatus. The dimensions of the case are 21″×13″×7.5″.

A hinged bottom sample holder plate was fabricated from aluminum. The bottom hinged plate (⅛″ thick) was approximately 12.25″ by 14″ with appropriate cutouts on its edges to allow clearance of latch mechanisms and the rounded corners of the case. A hole was drilled in the plate centered on and near the edge opposite the hinges. The whole receives a thumb screw for joining a prop rod described below. The sample holder plate was connected by means of two hinges at opposite ends of one side to the inside of the case near the bottom of the case when stood upright.

Two feet for supporting the underside of the bottom sample holder plate were fabricated from 1″ aluminium square stock. Blocks were cut to 1.5″ length, drilled and tapped to accept #10 thumb screws. The feet were attached to the corners of the bottom hinged plate on the side opposite the hinges with the thumb screws. An 8″×10″ auxiliary plate which mated with the inside surface of the bellows was fabricated from ⅛″ wood and covered on all sides with felt. This auxiliary plate was fastened to the top side of the sample holder plate with screws. The seal between the bellows and the auxiliary and sample holder plates was thereby made light tight. Additional light baffling could be provided by use of a removable light baffle comprising a square frame constructed of wood and painted black which could be placed on top of the auxiliary plate. The size of the light baffle allowed it to be entirely contained within the bellows.

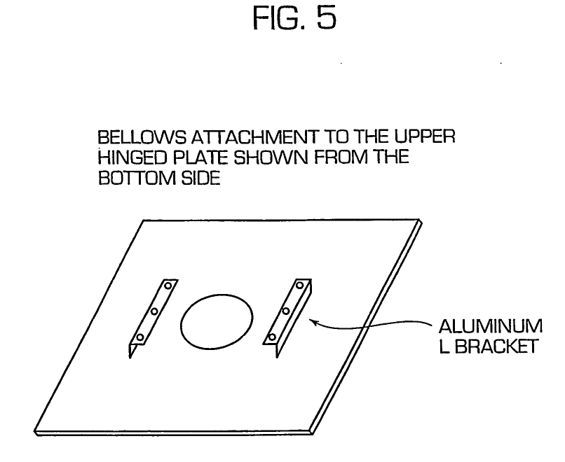

The top support plate shown in FIG. 5 consists of a 10″×12.25″×⅛″ aluminum plate with appropriate cutouts on its edges to allow clearance of latch mechanisms and the rounded corners of the case. The top support plate was connected by means of two hinges at opposite ends of one side to the inside of the case near the top of the case when stood upright. A 3″ diameter hole was drilled in the center of the plate. The hole allows passage of a camera lens. Two mounting brackets fabricated from and having an L-shaped cross section were attached to the lower face of the top support plate. The L-brackets were located on opposite sides of the central hole in a parallel arrangement at a separation distance suited to receive a flange on the bellows described below. The brackets sealably engage the flange with the top support plate. The top support plate was connected by means of two hinges at opposite ends of one side to the inside of the case near the top of the case when stood upright.

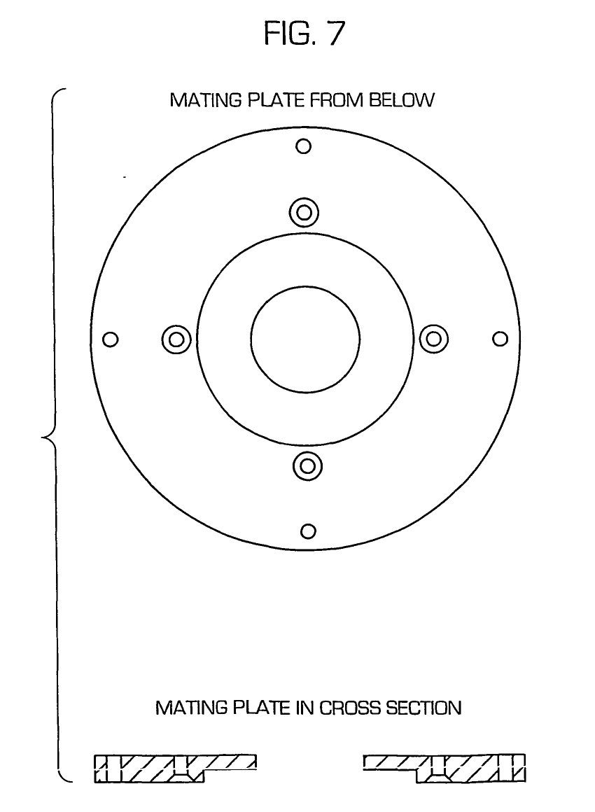

A mating plate consisted of ¼″ thick round aluminum plate, 4″ in diameter and is shown in FIG. 7 in bottom and cross sectional views. The mating plate is used to mount a Santa Barbara Instrument Group ST-7E camera head to the hinged top support plate of the portable camera assembly. The mating plate has a hole bored through and tapped in its center to accept standard C-mount threaded lenses. A circular area approximately 2″ in diameter near the center hole was thinned to approximately ⅛″. The mating plate was additionally bored through to accept countersunk machine screws which attach the camera head to the mating plate. The spacing of the mating plate holes is determined by the preexisting holes in the camera head. The mating plate was also bored and tapped to accept countersunk machine screws which allow it to be attached to the top side of the hinged top support plate of the portable camera assembly.

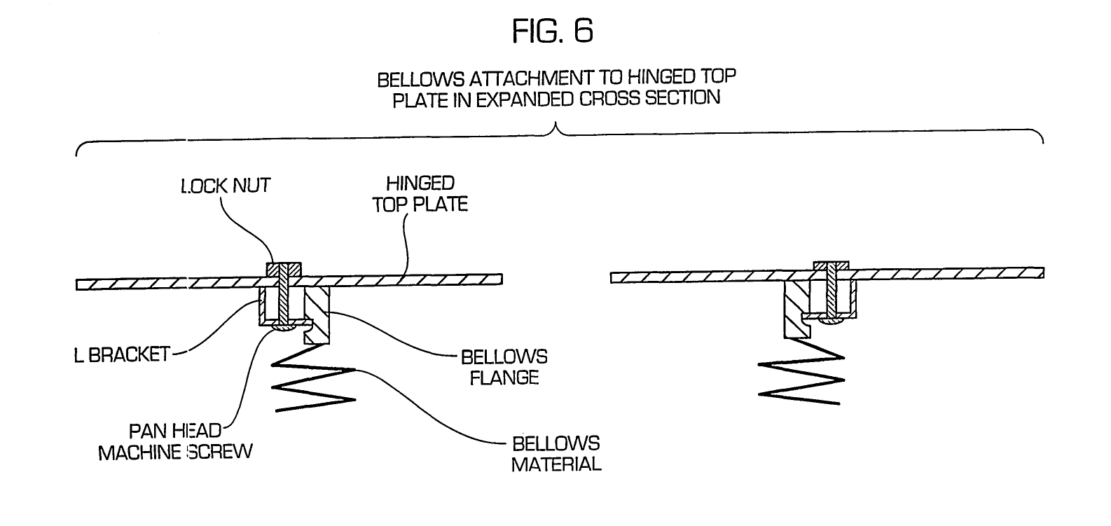

A Toyo 8″×10″ standard photographic bellows, model 180-708 was mounted to the bottom side of the top support plate (FIG. 6). The bellows is 6″×6″ on the top end and 8″×10″ on the bottom end. A flange on the small (top) end slides into and is held in place on opposite sides by the two L-brackets mounted to the under side of the top support plate.

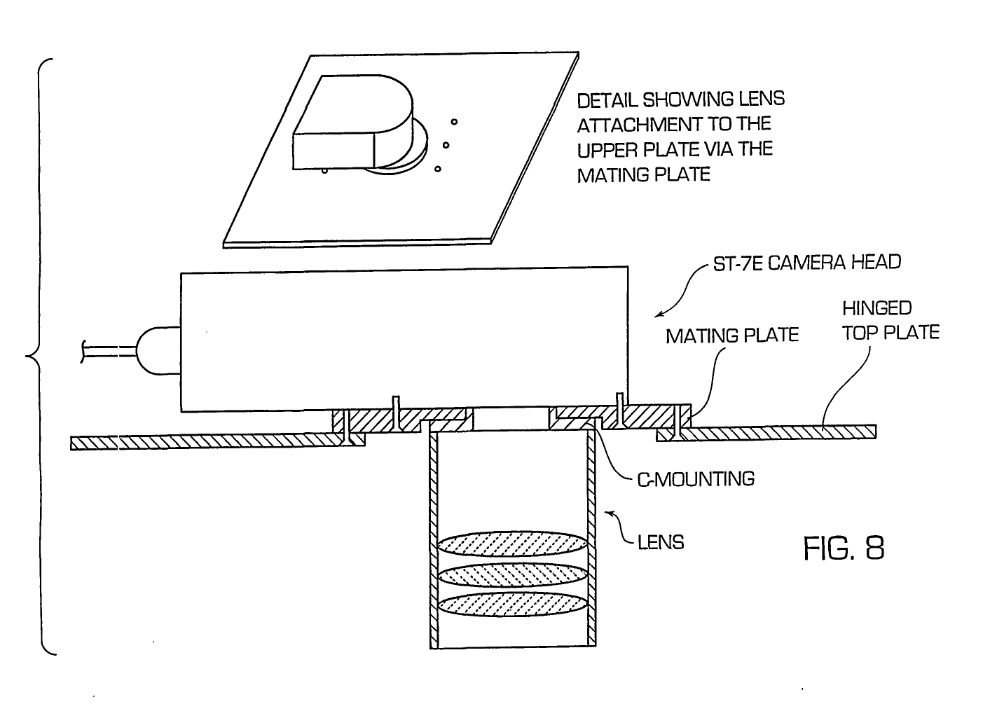

A Santa Barbara Instrument Group Model ST-7E CCD Camera was mounted onto the mating plate by machine screws. The camera contains a 765×510 pixel thermoelectrically cooled CCD chip. Pixel size is 9×9 μm making a total area of 6.9×4.6 mm. The camera has a 16 bit A/D converter with a 30 KHz digitization rate. A SCSI adaptor with power supply was provided for data transfer to an Apple Macintosh computer. The camera was fitted with a 50 mm C-mount lens (JML Optical, New York, N.Y.) threaded into the mating plate. Other lenses could be easily interchanged. FIG. 8 depicts cross section and top views of the assembly of the CCD camera head, mating plate, top support plate and camera lens.

A removable prop rod was fabricated from ½″ aluminum round rod. Use of the prop rod provided extra stability. Both ends of the rod were drilled and tapped to accept #10 threaded rod. The length was approximately 19″. The rod is placed between the top support plate and bottom sample holder plate when the apparatus is placed in the open configuration for use. Thumb nuts (#10 thread) tightened the prop rod to these top and bottom hinged plates. Removable hanging straps were attached to opposite sides of the top face of the top support plate. The straps project down from the top support plate approximately 3″ and have a lip at the end which hold the bottom (larger) end of the bellows in an nonextended or open position when desired.

### EXAMPLE OF USE

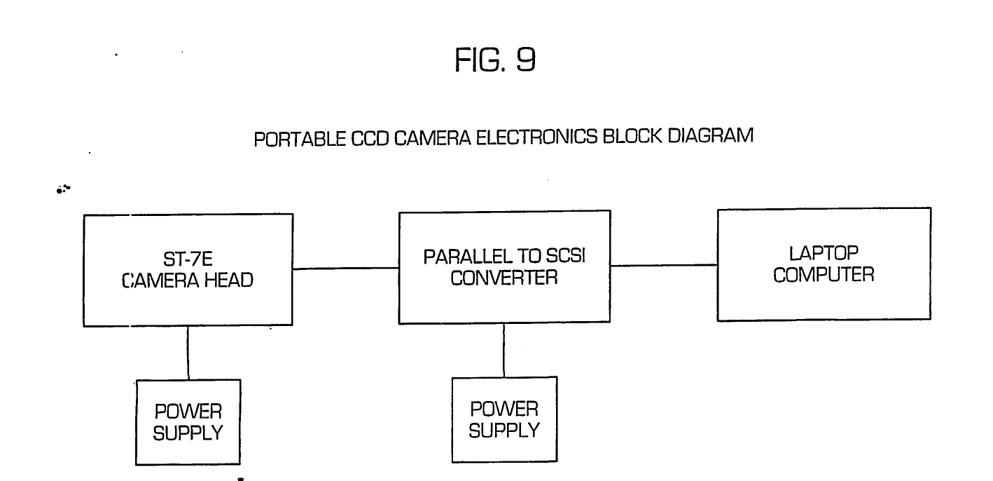

The apparatus described above was connected to a Macintosh PowerBook laptop computer (Apple Computer, Cupertino, Calif.) by means of a parallel-SCSI converter with associated power supply. A block diagram of the electronic system is depicted in FIG. 9. The operation of the camera is software controlled by a program supplied with the camera head by Santa Barbara Instruments Group (CCDOPS). For the following experiments, the camera head was cooled to 25° C. below ambient temperature via software control. Exposure time and resolution level were specified and exposure made. Operation of the software is described in detail in the software manual.

1. Western Blot Imaging

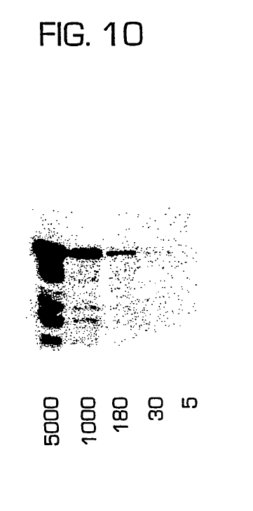

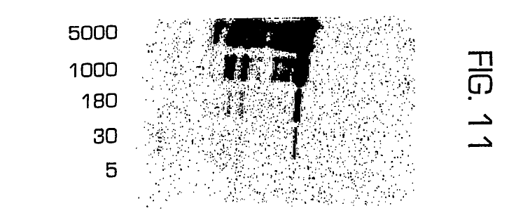

Dilutions of a solution of the protein β-galactosidase containing 5000, 1000, 180, 30 and 5 ng of protein were electrophoresed in a mini-gel and blotted onto either nitrocellulose or PVDF membrane by standard protocols. The transferred protein bands were bound on the membranes with unlabeled primary antibody followed by horseradish peroxidase-labeled secondary antibody. A chemiluminescent reagent for detection of peroxidase (Lumigen PS-3, Lumigen, Southfield, Mich.) was applied to the membrane. FIG. 10 depicts a 1 min exposure of the PVDF membrane which detected all five bands. FIG. 11 depicts a 2 min exposure of the nitrocellulose membrane which detected all five bands.

2. Dot Blot Imaging

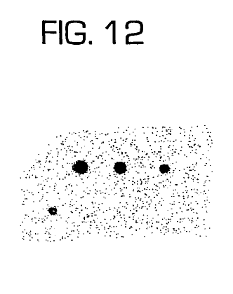

Digoxigenin-labeled DNA (pBR328), anti digoxigenin-alkaline phosphatase conjugate and positively charged nylon membrane were obtained from Boehringer-Mannheim (Indianapolis, Ind.). DNA dilutions (10, 3, 1, 0.3, 0.1, 0.03, 0.01 pg) were dot blotted onto nylon membranes, blocked, washed and reacted with antibody-AP conjugate according to the manufacturer's protocol. Blots were washed and blocked using customary procedures and then reacted with anti digoxigenin-AP conjugate. After a final wash, excess buffer was drained off and blots soaked in detection reagent (Lumigen CCD, Lumigen, Southfield, Mich.). Excess reagent was drained off, the blots placed between CCD camera imaging apparatus. FIG. 12 depicts a 30 s exposure which detected all seven spots.

The foregoing description and examples are illustrative only and not to be considered as restrictive. It is recognized that modifications of the specific elements and features of the apparatus not specifically disclosed can be made without departing from the spirit and scope of the present invention. The scope of the invention is limited only by the appended claims.

What is claimed is:

1. An apparatus for imaging a luminescent object placed within the apparatus comprising a photon detection device, a dark chamber and a sample holder, wherein the apparatus is adapted for storage within a carrying case wherein the apparatus has a closed configuration for storage and an open configuration for use.

2. The apparatus of claim 1 having at least one dimension which is larger when in the open configuration than any dimension of the closed carrying case.

3. The apparatus of claim 1 having at least one dimension which is larger when in the open configuration than a corresponding dimension of the closed carrying case.

4. The apparatus of claim 1 further comprising an expandable enclosure element for providing a dark chamber, a sample holding device, a photon detection device mounted to a support element and electronic means for producing electrical output signals coupled to the photon detection device.

5. The apparatus of claim 4 which when placed in the open configuration for use forms the dark chamber between the photon detection device and the sample holder wherein at least one dimension of the dark chamber is larger than any dimension of the closed carrying case.

6. The apparatus of claim 4 wherein at least one dimension of the dark chamber is larger than a corresponding dimension of the closed carrying case.

7. The apparatus of claim 4 which when placed in the open configuration for use has a dimension along an optical axis running from the photon detection device to the sample holder which is larger than any dimension of the closed carrying case.

8. The apparatus of claim 4 attached to an inside surface of the carrying case.

9. The apparatus of claim 1 having length, width and depth outside linear dimensions whose sum does not exceed 45 inches when in a closed configuration.

10. An imaging apparatus comprising:
an expandable enclosure element for providing a dark chamber;
a sample holding device;
a photon detection device mounted to a support element;
electronic means coupled to the photon detection device to produce electrical output signals, wherein the expandable enclosure element, sample holding device, photon detection device, support element and electronic means are contained within a carrying case.

11. The apparatus of claim 10 wherein the electronic means coupled to the photon detection device to produce electrical output signals, wherein the expandable enclosure element, sample holding device, and support element are attached to at least one inside surface of the carrying case.

12. The apparatus of claim 10 wherein the expandable enclosure element is attached to the support element and has a first retracted configuration for storage within the carrying case and a second expanded configuration for forming the dark chamber when the carrying case is in an opened configuration.

13. The apparatus of claim 12 wherein the expandable enclosure element is selected from a bellows device, a telescoping tube set, and a flexible cloth or fabric.

14. The apparatus of claim 10 further comprising at least one rigid support member positionable between the sample holding device and the support element to maintain a fixed separation between the photon detection device and the sample holding device.

15. The apparatus of claim 10 wherein the dark chamber is formed by expanding the enclosure element to an expanded configuration and attaching it to the sample holding device.

16. The apparatus of claim 10 wherein the photon detection device is selected from a CCD camera, a cooled CCD camera, an intensified CCD camera, and a photomultiplier tube.

17. The apparatus of claim 10 having length, width and depth outside linear dimensions whose sum does not exceed 45 inches when in a closed configuration.
